(19) United States
(12) Patent Application Publication
(10) Pub. No.: US 2024/0327291 A1
(43) Pub. Date: Oct. 3, 2024

(54) MULTIVALENT MANGANESE OXIDE FILLER, PREPARATION METHOD THEREFOR, AND APPLICATION THEREOF

(71) Applicant: CHONGQING UNIVERSITY, Chongqing (CN)

(72) Inventors: YI CHEN, Chongqing (CN); JINGYI DAI, Chongqing (CN); ZHIHAO XIAN, Chongqing (CN); SHUYUAN ZHAO, Chongqing (CN); XIN ZHANG, Chongqing (CN); HAO WU, Chongqing (CN); LANXI LI, Chongqing (CN); TAO LIU, Chongqing (CN)

(21) Appl. No.: 18/624,447

(22) Filed: Apr. 2, 2024

Related U.S. Application Data
(63) Continuation of application No. PCT/CN2023/137123, filed on Dec. 7, 2023.

(30) Foreign Application Priority Data
Mar. 27, 2023 (CN) 202310312127.6

(51) Int. Cl. C04B 35/01; C04B 35/626; C04B 35/64

(52) U.S. Cl. CPC C04B 35/016; C04B 35/6265; C04B 35/62655; C04B 35/62675; C04B 35/64; C04B 2235/3262; C04B 2235/6562; C04B 2235/6567

(57) ABSTRACT

The present invention discloses a multivalent manganese oxide filler, a preparation method therefor, and an application thereof. The preparation method comprises the following steps: step 1: adding a Eucalyptus robusta Smith leaf extract into a potassium permanganate solution for oxidation reaction, and stirring to finally form a suspension; step 2: sequentially filtering and drying the suspension in the step 1 to obtain a sintering precursor; and step 3: sintering the sintering precursor to obtain the multivalent manganese oxide filler. According to the present invention, through the combination of oxidation reaction and sintering reaction in the present invention, the multivalent manganese oxide filler containing manganese (II), manganese (III) and manganese (IV) is prepared, and the filler is loose and porous; in addition, the oxidation reaction and the sintering reaction are combined in the present invention, so that the process difficulty of preparing the multivalent manganese oxide is reduced.

### CROSS-REFERENCE TO RELATED APPLICATIONS

This application is a continuation of International Application No. PCT/CN2023/137123, filed on Dec. 7, 2023, which claims priority to Chinese Patent Application No. 202310312127.6, filed on Mar. 27, 2023. The disclosures of the aforementioned applications are hereby incorporated by reference in their entireties.

### TECHNICAL FIELD

The present invention relates to the technical field of constructed wetland nitrogen removal, and specifically to a multivalent manganese oxide filler, a preparation method therefor, and an application thereof.

### BACKGROUND

A constructed wetland is an emerging ecological treatment technology in recent years. Compared with conventional activated-sludge method, the constructed wetland has the advantages of low operation cost, good wastewater treatment effect, simple operation, convenient maintenance and significant ecological benefit, and thus is very suitable for treating the scattered domestic sewage in villages and towns.

The constructed wetland nitrogen removal is characterized by a complex mechanism, and usually includes nitrification and denitrification, plant absorption, substrate adsorption and volatilization. Nitrification-denitrification is considered the main mode of the constructed wetland nitrogen removal, accounting for more than 50% of nitrogen removal. However, due to the special flooding structure of the constructed wetland, the oxygen provided by atmospheric reoxygenation (5.77-18.45 g O2m-2d-1) and root oxygen secretion (0.005-12 g O2m-2d-1) is far less than the consumed oxygen (450 g O2m-2d-1). A large gap between oxygen supply and oxygen consumption results in often anaerobic or anoxic conditions in the constructed wetland. In addition, because the sewage contains fewer organic carbon sources and lacks electron donors, the denitrification of the constructed wetland is also inhibited. Meanwhile, due to the lack of dissolved oxygen (DO) and electron donors in the constructed wetland, nitrification and denitrification are always inhibited, which causes the effect of the conventional constructed wetland nitrogen removal to be unsatisfactory (40-55%). Therefore, corresponding technologies and processes are required for solving this problem.

In recent years, studies have shown that mineral oxides such as iron oxide (FeOx) and manganese oxide (MnOx) can serve as electron acceptors to mediate nitrogen cycling under an anoxic condition. Compared with FeOx, MnOx has a lower zero-charge point (1.5-4.6), is 5-6 times more efficient in microbial metabolism, and thus is a promising nitrogen removal material. At present, the nitrogen removal process of MnOx (Mn3+/Mn4+) is mainly achieved by the coupling of MnOx reduction and nitrification processes and the direct mediation of anaerobic ammonium oxidation process (Mnammox), which are detailed in formulas (1) to (3):

$$4 {MnO}_{2} + {{NH}_{4}}^{+} + 6 {H}^{+} \to 4 {Mn}^{2 +} + {{NO}_{3}}^{-} + 5 {H}_{2} O \qquad ( 1 )$$

$$3 {MnO}_{2} + {{NH}_{4}}^{+} + 4 {H}^{+} \to 3 {Mn}^{2 +} + {{NO}_{2}}^{-} + 4 {H}_{2} O \qquad ( 2 )$$

$$3 {MnO}_{2} + 2 {{NH}_{4}}^{+} + 4 {H}^{+} \to 3 {Mn}^{2 +} + {N}_{2} + 6 {H}_{2} O \qquad ( 3 )$$

At present, the preparation method for manganese oxide mainly comprises a hydrothermal synthesis method, a chemical precipitation method, a sol-gel method, a template method and the like. However, these methods have many disadvantages. For example, the hydrothermal synthesis method requires a high-temperature high-pressure acidic environment, the chemical precipitation method requires repeated washing, the sol-gel method requires precursors such as metal alkoxides, and the template method requires high cost.

Therefore, a method having low consumption, low cost, energy conservation, environmental protection, mild conditions and simple process becomes the main target of the current constructed wetland filler production.

### SUMMARY

A first objective of the present invention is to provide a preparation method for a multivalent manganese oxide filler, which aims to solve the problem that the preparation of existing manganese oxide is not environment-friendly.

A technical solution of the present invention for solving the above technical problem is as follows.

A preparation method for a multivalent manganese oxide filler comprises the following steps:
step 1: adding a Eucalyptus robusta Smith leaf extract into a potassium permanganate solution for oxidation reaction, and stirring to finally form a suspension;
step 2: sequentially filtering and drying the suspension in the step 1 to obtain a sintering precursor; and
step 3: sintering the sintering precursor to obtain the multivalent manganese oxide filler.

The beneficial effects of the present invention are as follows: through the combination of oxidation reaction and sintering reaction in the present invention, the multivalent manganese oxide filler containing manganese (II), manganese (III) and manganese (IV) is prepared, and the filler is loose and porous; in addition, the oxidation reaction and the sintering reaction are combined in the present invention, so that the process difficulty of preparing the multivalent manganese oxide is reduced, and the later industrialization is facilitated to a certain extent.

Based on the above technical solution, the present invention may be further improved as follows.

Further, the oxidation reaction in the step 1 is performed for 2-3 h at room temperature.

Further, a solid-to-liquid ratio of the suspension in the step 1 is (2-3):50 g/mL.

Further, the Eucalyptus robusta Smith leaf extract in the step 1 has a particle size of 74-100 μm, and the potassium permanganate solution in the step 1 has a molar concentration of 0.15-0.3 mol/L.

Further, the drying in the step 2 is performed at a temperature of 70-80° C. for 24-36 h.

Further, the sintering in the step 3 is performed at a heating rate is 8-12° C./min and at a temperature of 600-900° C. in an atmosphere of air for 3-4 h.

Further, the sintering in the step 3 is performed at a heating rate is 10° C./min and at a temperature of 600° C. in an atmosphere of air for 3 h.

A second objective of the present invention is to provide a multivalent manganese oxide filler prepared according to the first objective.

A third objective of the present invention is to provide an application of the multivalent manganese oxide filler according to the second objective in the constructed wetland nitrogen removal.

The present invention has the following beneficial effects.
1. The manganese oxide filler prepared in the present invention has a loose and porous structure characteristic and has a strong purification function on the environment when being used as the constructed wetland filler. Meanwhile, this manganese oxide filler has an efficient nitrogen removal function and promotes the growth and development of wetland vegetation, so that the constructed wetland can better play an ecological protection function.
2. The multivalent manganese oxide filler according to the present invention is prepared based on the Eucalyptus robusta Smith leaf extract, and the Eucalyptus robusta Smith leaf extract plays a role of a reducing agent and a template agent for the generation of the multivalent manganese oxide filler. Specifically, the Eucalyptus robusta Smith leaf extract is rich in a large amount of amino acids, proteins, saccharides, vitamins, organic amines and quaternary ammonium ions, wherein reducing sugars and amino acids in the saccharides react with potassium permanganate to reduce MnO4- into manganese with different low valence states (III and IV); the organic amines and quaternary amine ions in the Eucalyptus robusta Smith leaf extract play a role of a structure template in the preparation process of the multivalent manganese oxide filler. Specifically, the organic amines and quaternary amine ions (1) play a role of structural guidance, that is, change the chemical property of a substance by adding an organic matter, provide a certain template action for the formation of a final filling structure, and then form a mesoporous material with a specific crystal phase by calcination; (2) play a role in filling space in the filler framework and can stabilize the finally generated structure; and (3) act to balance the charge of the product framework.

Therefore, the present invention finally forms the multivalent manganese oxide filler with stable chemical components and structure, which is beneficial to the utilization and growth of microorganisms and has a high-efficiency nitrogen removal effect when being used for the constructed wetland. In addition, the Eucalyptus robusta Smith leaf extract in the present invention can also be extracted from waste Eucalyptus robusta Smith leaves. Therefore, the present invention has the advantages of wide raw material source, low cost and the like.
3. According to the present invention, through the combination of oxidation reaction and sintering reaction in the present invention, the multivalent manganese oxide filler containing manganese (II), manganese (III) and manganese (IV) is prepared, and the filler is loose and porous; in addition, the oxidation reaction and the sintering reaction are combined in the present invention, so that the process difficulty of preparing the multivalent manganese oxide is reduced, and the later industrialization is facilitated to a certain extent.

### BRIEF DESCRIPTION OF THE DRAWINGS

FIG. 1 is an SEM image, in which FIG. 1a and FIG. 1c are SEM images of a sintering precursor, and FIG. 1b and FIG. 1d are SEM images of a multivalent manganese oxide filler;

FIG. 2 is an EDS pattern, in which (a) is an EDS pattern of a sintering precursor, and (b) is an EDS pattern of a multivalent manganese oxide filler;

FIG. 3 is an FTIR plot of a sintering precursor and a multivalent manganese oxide filler;

FIG. 4 is an XPS diagram, in which (a) is an XPS diagram of a sintering precursor, and (b) is an XPS diagram of a multivalent manganese oxide filler;

FIG. 5 shows a concentration change curve of ammonia nitrogen removal by a multivalent manganese oxide filler;

FIG. 6 shows a concentration change curve of nitrate removal by a multivalent manganese oxide filler;

FIG. 7 shows a concentration change curve of total nitrogen removal by a multivalent manganese oxide filler;

FIG. 8 shows a concentration change curve of chemical oxygen demand (COD) removal by a multivalent manganese oxide filler;

FIG. 9 shows a concentration change curve of ammonia nitrogen removal by a filler prepared from different extracts;

FIG. 10 shows a concentration change curve of nitrate removal by a filler prepared from different extracts; and

FIG. 11 shows a concentration change curve of total nitrogen removal by a filler prepared from different extracts.

### DESCRIPTION OF EMBODIMENTS

The following describes a multivalent manganese oxide filler, a preparation method therefor, and an application thereof in the present invention with reference to examples.

However, the present invention may be illustrated in many different forms and should not be construed as limited to the specific embodiments described herein. Rather, these embodiments are provided so that the present invention will be thorough and complete, and will fully convey the scope of the present invention to those skilled in the art.

The inventor found through extensive research that the existing manganese oxide preparation process is complex and does not meet environmental protection requirements, and the existing manganese oxide has low nitrogen removal efficiency.

Based on this, an embodiment of a first aspect of the present invention provides a preparation method for a multivalent manganese oxide filler, which comprises the following steps:
step 1: adding a Eucalyptus robusta Smith leaf extract into a potassium permanganate solution for oxidation reaction, and stirring to finally form a suspension;
step 2: sequentially filtering and drying the suspension in the step 1 to obtain a sintering precursor; and
step 3: sintering the sintering precursor to obtain the multivalent manganese oxide filler.

The Eucalyptus robusta Smith leaf extract in this embodiment is rich in a large amount of amino acids, proteins, saccharides (including reducing sugars), vitamins, organic amines and quaternary ammonium ions, such as macrocarpal A, macrocarpal B, macrocarpal C, macrocarpal D, macrocarpal E, n-triacontane-16,18-dione and flavonoid compounds; therefore, after this extract is mixed with a potassium permanganate solution, an oxidation reaction occurs, and reducing sugars in the Eucalyptus robusta Smith leaf extract and amino acids act together to reduce MnO4- to generate manganese with different low valence states (III and IV).

The sintering may convert manganese (IV) in the precursor into manganese with different valence states, and the reaction formulas are as follows (4)-(5):

$$4 {MnO}_{2} = 2 {Mn}_{2} {O}_{3} + {O}_{2} \qquad ( 4 )$$

$$6 {Mn}_{2} {O}_{3} = 4 {Mn}_{3} {O}_{4} + {O}_{2} ; \qquad ( 5 )$$

in addition, the organic amines and quaternary amine ions in the Eucalyptus robusta Smith leaf extract play a role of a structure template in the generation of the multivalent manganese oxide filler. Specifically, the organic amines and quaternary amine ions (1) play a role of structural guidance, that is, change the chemical property of a substance by adding an organic matter, provide a certain template action for the formation of a final filling structure, and then form a mesoporous material with a specific crystal phase by calcination; (2) play a role in filling space in the filler framework and can stabilize the finally generated structure; and (3) act to balance the charge of the product framework.

That is, the present invention combines oxidation reaction and sintering reaction to generate the multivalent manganese oxide filler containing manganese (II), manganese (III) and manganese (IV); in addition, the multivalent manganese oxide prepared in the present invention has a loose and porous structure characteristic and has a higher nitrogen removal effect. Meanwhile, the oxidation reaction and the sintering reaction are combined, so that the difficulty of the preparation process of the multivalent manganese oxide is reduced.

In addition, the Eucalyptus robusta Smith leaf extract in this embodiment is commercially available, and the Eucalyptus robusta Smith leaf extract in this embodiment is produced by Shaanxi Suo'ao Biotechnology Co., Ltd.

Furthermore, in some embodiments, the oxidation reaction in the step 1 is performed for 2-3 h at room temperature. Under this reaction condition, it is ensured that potassium permanganate is completely reduced to low-valent manganese oxide by reducing sugars and amino acids in the Eucalyptus robusta Smith leaf extract. In addition, in this embodiment, the stirring speed is usually 400 rpm.

Furthermore, in some embodiments, a solid-to-liquid ratio of the suspension in the step 1 is (2-3):50 g/mL. The solid-to-liquid ratio in this range ensures the preparation yield and effect of the multivalent manganese oxide filler, which avoids the phenomenon that the Eucalyptus robusta Smith leaf extract powder is too much and finally does not completely react with the potassium permanganate solution when the solid-to-liquid ratio exceeds this range, and also avoids the waste or overreaction of potassium permanganate caused by too little Eucalyptus robusta Smith extract powder when the solid-to-liquid ratio is lower than this range. Preferably, the solid-to-liquid ratio of the suspension in this embodiment is: 3:50 g/mL.

Furthermore, in some embodiments, the Eucalyptus robusta Smith leaf extract in the step 1 has a particle size of 74-100 μm, and the potassium permanganate solution in the step 1 has a molar concentration of 0.15-0.3 mol/L. Firstly, in this embodiment, the Eucalyptus robusta Smith leaf extract with the above particle size and the potassium permanganate solution can form a suspension more easily, so that the sufficient oxidation reaction of the Eucalyptus robusta Smith leaf extract and the potassium permanganate is facilitated; the potassium permanganate solution in the above molar concentration range ensures that potassium permanganate in the suspension with the solid-to-liquid ratio of (2-3):50 g/mL can completely react with the Eucalyptus robusta Smith leaf extract, and avoids the influence of excessive or insufficient potassium permanganate on the generated multivalent manganese oxide. Preferably, the molar concentration of the potassium permanganate solution in this embodiment is 0.2 mol/L.

Furthermore, in some embodiments, the drying in the step 2 is performed at a temperature of 70-80° C. for 24-36 h.

Furthermore, in some embodiments, the sintering in the step 3 is performed at a heating rate is 8-12° C./min and at a temperature of 600-900° C. in an atmosphere of air for 3-4 h. Sintering under the condition is beneficial to MnO2 to form oxides with different manganese valence states (see the above formula (4) and the formula (5)), avoids the decomposition of organic substances in the Eucalyptus robusta Smith leaf extract due to too high temperature, and also avoids the incomplete decomposition of the Eucalyptus robusta Smith leaf extract caused by too low temperature, which affects the conversion of MnO2 to form manganese oxides with different valence states. Preferably, the sintering in the step 3 is performed at a heating rate is 10° C./min and at a temperature of 600° C. in an atmosphere of air for 3 h. Under this condition, the organic substances in the Eucalyptus robusta Smith leaf extract as a template can be completely decomposed, the specific surface area of the multivalent manganese oxide filler is increased to a certain extent, and meanwhile, the energy consumption is low.

An embodiment of a second aspect of the present invention provides a multivalent manganese oxide filler prepared according to the embodiment of the first aspect. The multivalent manganese oxide filler in the present invention has a loose and porous structure characteristic and has a higher nitrogen removal effect.

An embodiment of a third aspect of the present invention provides an application of the multivalent manganese oxide filler according to the embodiment of the second aspect in the constructed wetland nitrogen removal.

### EXAMPLE

### Example 1

A preparation method for a multivalent manganese oxide filler comprises the following steps:
Step 1: adding a Eucalyptus robusta Smith leaf extract with a particle size of 74 μm into a potassium permanganate solution with a molar concentration of 0.15 mol/L for oxidation reaction, and stirring to form a suspension; wherein the oxidation reaction is performed for 2 h at room temperature, a solid-to-liquid ratio of the suspension is 2:50 g/m., and the stirring speed is 400 rpm.
Step 2: sequentially filtering, washing and drying the suspension in the step 1 to obtain a sintering precursor; wherein the drying is performed at a temperature of 70° C. for 24 h.
Step 3: sintering the sintering precursor to prepare the multivalent manganese oxide filler; wherein the sintering is performed at a heating rate is 8° C./min and at a temperature of 700° C. in an atmosphere of air for 4 h.

### Example 2

A preparation method for a multivalent manganese oxide filler comprises the following steps:
Step 1: adding a Eucalyptus robusta Smith leaf extract with a particle size of 74 μm into a potassium permanganate solution with a molar concentration of 0.2 mol/L for oxidation reaction, and stirring to form a suspension; wherein the oxidation reaction is performed for 3 h at room temperature, a solid-to-liquid ratio of the suspension is 3:50 g/mL, and the stirring speed is 400 rpm.
Step 2: sequentially filtering, washing and drying the suspension in the step 1 to obtain a sintering precursor; wherein the drying is performed at a temperature of 75° C. for 26 h.
Step 3: sintering the sintering precursor to prepare the multivalent manganese oxide filler; wherein the sintering is performed at a heating rate is 10° C./min and at a temperature of 600° C. in an atmosphere of air for 3 h.

### Example 3

A preparation method for a multivalent manganese oxide filler comprises the following steps:
Step 1: adding a Eucalyptus robusta Smith leaf extract with a particle size of 100 μm into a potassium permanganate solution with a molar concentration of 0.3 mol/L for oxidation reaction, and stirring to form a suspension; wherein the oxidation reaction is performed for 3 h at room temperature, a solid-to-liquid ratio of the suspension is 2.5:50 g/mL, and the stirring speed is 400 rpm.
Step 2: sequentially filtering, washing and drying the suspension in the step 1 to obtain a sintering precursor; wherein the drying is performed at a temperature of 80° C. for 36 h.
Step 3: sintering the sintering precursor to prepare the multivalent manganese oxide filler; wherein the sintering is performed at a heating rate is 12° C./min and at a temperature of 900° C. in an atmosphere of air for 3 h.

### Comparative Example 1

The preparation method for the manganese oxide filler in this example is the same as the preparation method for the multivalent manganese oxide filler in Example 2, except that: the Eucalyptus robusta Smith leaf extract is replaced with an Eucommia ulmoides leaf extract, and the Eucommia ulmoides leaf extract in this example is produced by Shaanxi Suo'ao Biotechnology Co., Ltd.

### Comparative Example 2

The preparation method for the manganese oxide filler in this example is the same as the preparation method for the multivalent manganese oxide filler in Example 2, except that: the Eucalyptus robusta Smith leaf extract is replaced with a Platycladus orientalis leaf extract, and the Platycladus orientalis leaf extract in this example is produced by Shaanxi Suo'ao Biotechnology Co., Ltd.

Test analysis:

### 1. SEM and EDS Test Analysis

(1) The multivalent manganese oxide filler finally prepared in Example 2 (i.e., the Eucalyptus leaf extract after calcination) and the sintering precursor prepared in the step 2 in Example 2 (i.e., the Eucalyptus leaf extract before calcination) were subjected to SEM and EDS test analysis.

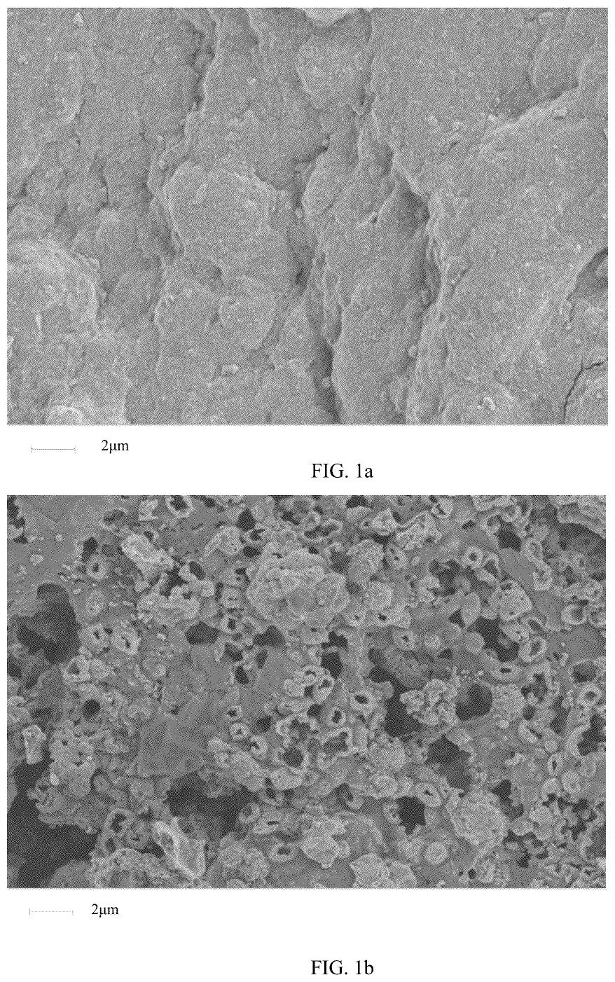

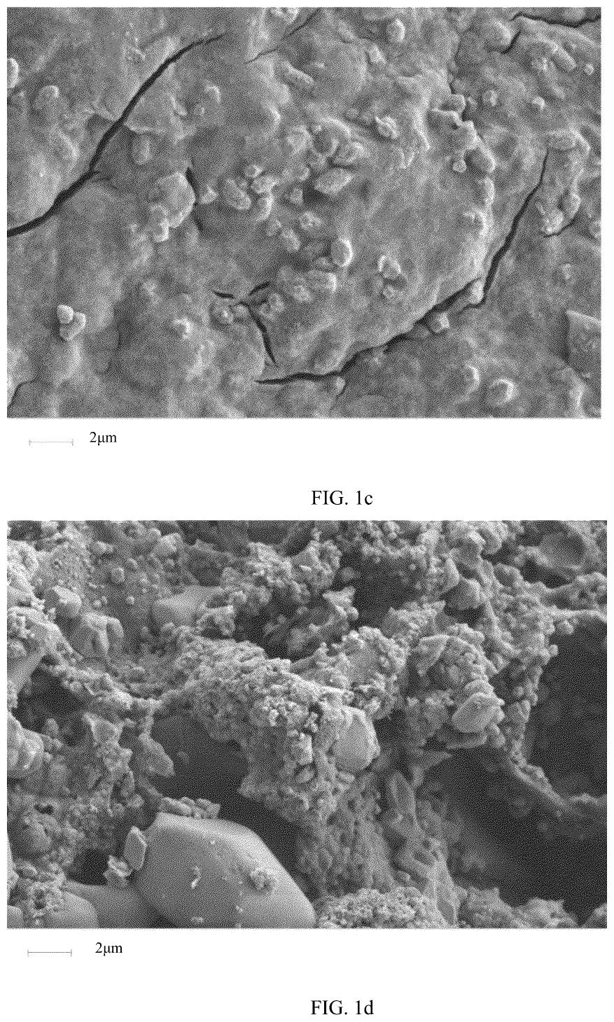

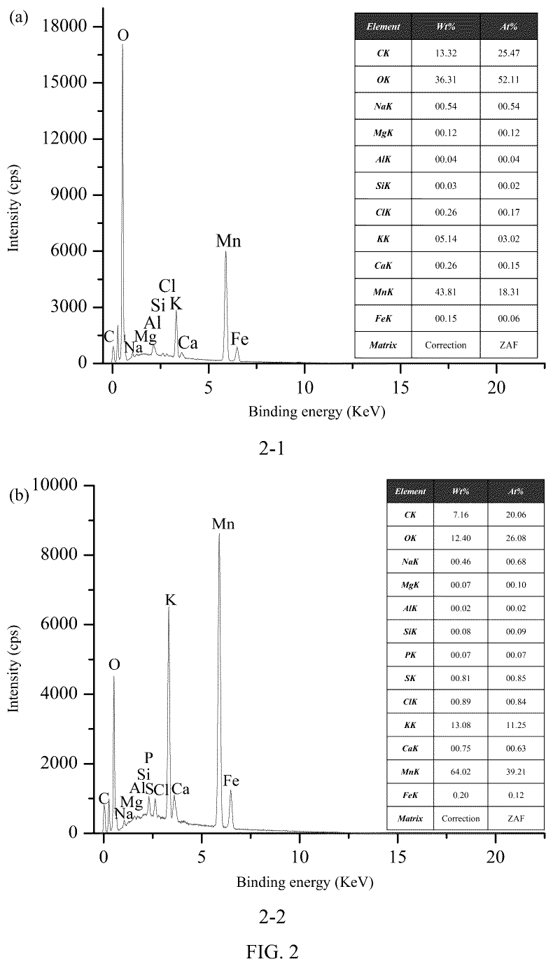

The test results are shown in FIGS. 1 and 2, in which (a) and (c) in FIG. 1 are SEM images of the sintering precursor, and (b) and (d) are SEM images of the multivalent manganese oxide filler.

It can be seen from (a) and (b) in FIG. 1 that the multivalent manganese oxide filler prepared after calcination has a distinct porous structure compared with the sintering precursor. In addition, it can be seen through further observing the magnified SEM images (i.e., (c) and (d)) of the sintering precursor and the multivalent manganese oxide filler that the sintering precursor has partial wrinkles and ravines, but the whole is relatively compact with small and few voids; while the multivalent manganese oxide filler has significantly increased wrinkles and pores, and the surface of the multivalent manganese oxide filler is in an uneven and loose granular structure.

In the present invention, the pore structure on the multivalent manganese oxide filler is the basis of the filler with larger specific surface area and good adsorption performance; the reason for pore formation is: the volatilization of organic compounds (i.e., the Eucalyptus robusta Smith leaf extract) during the calcination process. Meanwhile, this also indicates that the interaction between the Eucalyptus robusta Smith leaf extract and the manganese ions in the pyrolysis process improves the pore structure of the biomass of the sintering precursor to a certain extent, achieves the pore expansion effect to a certain extent, and increases the specific surface area and the number of the pore structures of the multivalent manganese oxide filler structure.

(2) The sintering precursor and the multivalent manganese oxide filler were tested and analyzed by using an X-ray energy spectrum. The test result is shown in FIG. 2, in which (a) is an EDS pattern of the sintering precursor, and (b) is an EDS pattern of the multivalent manganese oxide filler.

It can be seen from FIG. 2 that elements such as C, O, Na, K and Mg are uniformly distributed in the sintering precursor and the multivalent manganese oxide filler; wherein, compared with the sintering precursor, the proportion of O element in the material of the multivalent manganese oxide filler is significantly reduced, but the Mn is significantly increased to 64.02%. It is further confirmed that the Mn element exists and is distributed on the surface of the multivalent manganese oxide filler, and the content of the Mn element on the surface of the filler is significantly improved through calcination.

In addition, a small amount of P and S elements exist in the multivalent manganese oxide filler, which indicates that the structure and the property of the sintering precursor are changed by promoting the reaction of the Eucalyptus robusta Smith leaf extract and manganese ions through calcination, so that partial elements in the material are released, the growth of microorganisms is facilitated, and the result is consistent with the SEM characterization result.

### 2. Fourier Transform Infrared Spectroscopy (FTIR) Test Analysis

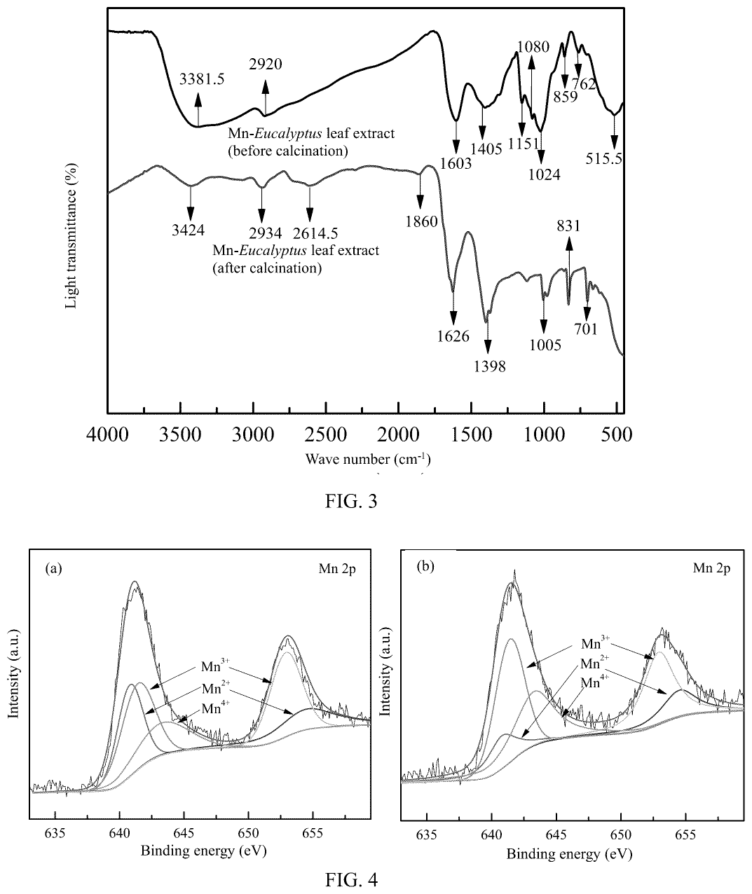

The multivalent manganese oxide filler finally prepared in Example 2 (i.e., the Eucalyptus leaf extract after calcination) and the sintering precursor prepared in the step 2 in Example 2 (i.e., the Eucalyptus leaf extract before calcination) were subjected to infrared spectroscopy analysis. The test results are shown in FIG. 3.

It can be seen from FIG. 3 that 3500-2500 cm-1 absorption band is caused by the stretching vibration of —OH; and the 2936-2916 cm-1 absorption band is caused by the asymmetric stretching vibration of —CH2. Compared with the sintering precursor, the multivalent manganese oxide filler shows 2 new peaks at 2614.5 cm-1 and 1860 cm-1, which correspond to the stretching vibrations of —COOH and C═O, respectively. This indicates that the amounts of —COOH and C═O in the filler are increased by calcination, and the increased —COOH and C═O are beneficial to the adhesion growth of microorganisms, thereby improving the nitrogen removal capability of the multivalent manganese oxide filler.

### 3. XPS Test Analysis

The multivalent manganese oxide filler finally prepared in Example 2 (i.e., the Eucalyptus leaf extract after calcination) and the sintering precursor prepared in the step 2 in Example 2 (i.e., the Eucalyptus leaf extract before calcination) were subjected to XPS analysis. The test results are shown in FIG. 4, in which (a) is an XPS diagram of the sintering precursor, and (b) is an XPS diagram of the multivalent manganese oxide filler.

FIG. 4 is the Mn2p spectrum of the sintering precursor and the multivalent manganese oxide filler. It can be seen from FIG. 4 that the doublets at 641.9 eV and 653.40 eV are respectively related to the binding energies of Mn2p3/2 and Mn2p1/2, and the spin energy split between the Mn2p3/2 and Mn2p1/2 doublets is 11.5 eV The main peak of Mn2p3/2 is deconvoluted into three peaks at 640.80 eV, 641.4 eV and 643.3 eV, attributable to the oxidation states of Mn, MnO, Mn203 and MnO2. The main peak of Mn2p1/2 is deconvoluted into two peaks at 652.9 eV and 654.5 eV, attributable to the oxidation states of Mn, Mn203 and MnO. Since the peak is related to the area enclosed by the abscissa and the element content, it can be seen from the figure that the content of Mn2+ in the multivalent manganese oxide filler is decreased, and the contents of Mn3+ and Mn4+ are increased. This further proves that the successful synthesis and calcination of the multivalent manganese oxide change the content of manganese with different valence states in the filler; in addition, the increase of oxidation states of manganese (3+ and 4+) after calcination promotes the manganese ammoxidation process under anaerobic conditions, thereby being beneficial to the constructed wetland nitrogen removal.

4. The nitrogen removal performance of the multivalent manganese oxide filler prepared in Example 2 was tested. The test method specifically was as follows: a cylindrical constructed wetland reactor with a height of 50 cm and an inner diameter of 10 cm was used for testing, during testing, a mixture of the multivalent manganese oxide filler and gravel was placed in a section 5-45 cm away from a bottom of a reactor, the influent water was fed in from the top and discharged out from the bottom, and the grass planted in the constructed wetland was windmill grass, with HRT=5d.

In addition, during testing, the following different groups of constructed wetlands were set according to different volumes of the multivalent manganese oxide filler and the gravel in the mixture, specifically:
group A (5% Mn-Eucalyptus leaf extract after calcination (namely, multivalent manganese oxide)), the volume ratio of the multivalent manganese oxide filler to the gravel was 5%, and gravel was filled in the rest positions of the constructed wetland reactor;
group B (15% Mn-Eucalyptus leaf extract after calcination), the volume ratio of the multivalent manganese oxide filler to the gravel was 15%, and gravel was filled in the rest positions of the constructed wetland reactor;
group C (25% Mn-Eucalyptus leaf extract after calcination), the volume ratio of the multivalent manganese oxide filler to the gravel was 25%, and gravel was filled in the rest positions of the constructed wetland reactor; and
control group (conventional constructed wetland), the substrate of the constructed wetland reactor was only gravel.

In addition, the influent water (i.e., simulated raw water) during test was configured with reference to general domestic sewage (COD=210 mg/L, NH4+—N concentration was 35 mg/L, TN concentration was 35 mg/L). Specifically, 2.1675 g of glucose, 1.3375 g of ammonium chloride, 0.1 g of ferrous chloride tetrahydrate, 0.2195 g of monopotassium phosphate, 0.2 g of EDTA-Na, 0.1 g of calcium chloride dihydrate, 0.6 g of magnesium chloride hexahydrate, 1 g of sodium bicarbonate and 2 mL of trace element concentrated solution (prepared from zinc sulfate, manganese chloride, cobalt chloride, copper chloride, boric acid, nickel chloride and sodium molybdate) were dissolved in 10 L of tap water to prepare the influent water, wherein the COD concentration in the influent water was 210 mg/L, and the NH4+—N concentration was 35 mg/L. In addition, during testing, the system was measured after being stabilized, the hydraulic retention time was 5 days, the sampling was performed once every two days, and the COD, ammonia nitrogen, nitrate nitrogen and total nitrogen concentrations of effluent water were measured after the effluent water was filtered by a 0.45 μm filter head after each sampling.

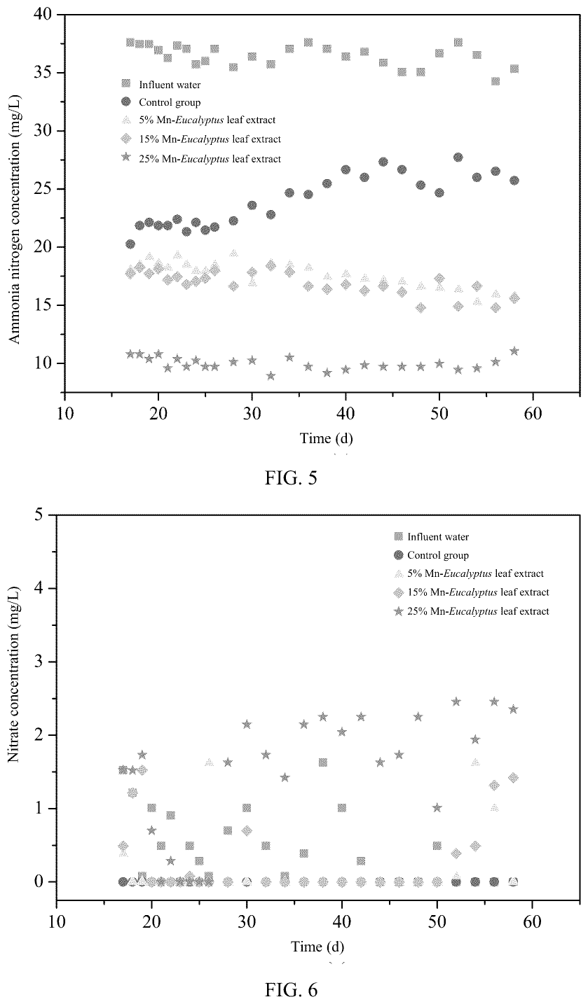

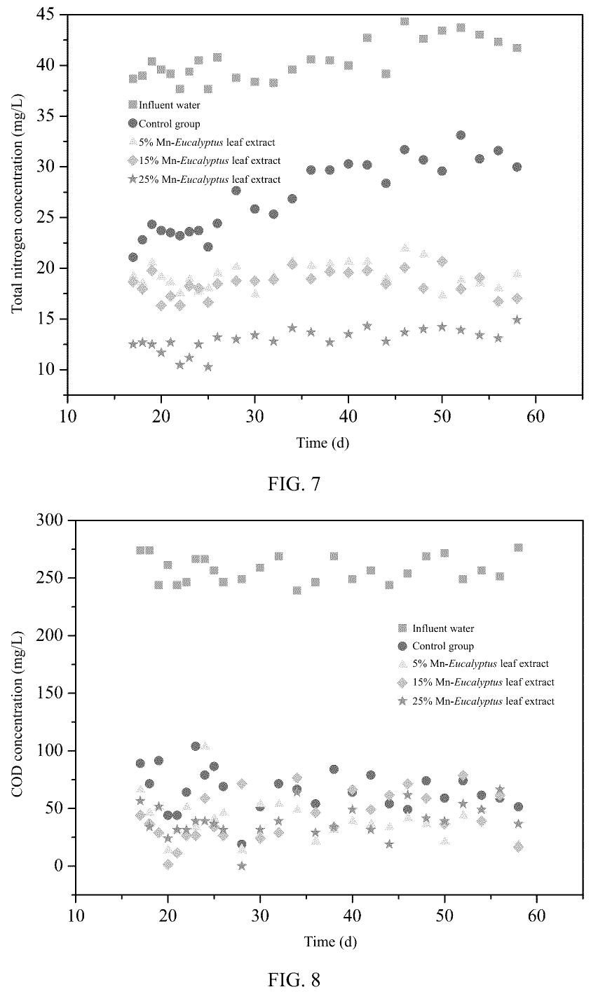

The test results are shown in FIGS. 5-8, wherein FIG. 5 shows a concentration change curve of ammonia nitrogen removal by the multivalent manganese oxide filler, FIG. 6 shows a concentration change curve of nitrate removal by the multivalent manganese oxide filler, FIG. 7 shows a concentration change curve of total nitrogen removal by the multivalent manganese oxide filler, and FIG. 8 shows a concentration change curve of chemical oxygen demand (COD) removal by the multivalent manganese oxide filler.

It can be seen from FIG. 5 that the constructed wetland with the multivalent manganese oxide filler in the present invention has a significantly better ammonia nitrogen removal effect than conventional constructed wetland, and the higher the ratio of the multivalent manganese oxide filler is, the better the ammonia nitrogen removal effect is. This indicates that the multivalent manganese oxide prepared in the present invention has good ammonia nitrogen removal performance.

It can be seen from FIG. 6 that the test group with the highest ratio of multivalent manganese oxide (i.e., group C) has the highest nitrate content, followed by the test group with the ratio of 5% (group A) and 15% (group B), and the control group has the lowest nitrate content, almost 0. The reason is that the nitrification process and the manganese ammonia oxidation process of the test group with the highest ratio are performed to a greater extent, the ammonia nitrogen removal effect is better, and more nitrates are generated as intermediate products, which corresponds to the above ammonia nitrogen results.

It can be seen from FIG. 7 that the concentration change trend of total nitrogen in each test group is similar to that of ammonia nitrogen, the total nitrogen removal effect of the constructed wetland with the multivalent manganese oxide filler is significantly better than that of the conventional constructed wetland, and the higher the ratio of the multivalent manganese oxide is, the better the total nitrogen removal effect is. This indicates that the multivalent manganese oxide prepared in the present invention has good total nitrogen removal performance, and is a promising nitrogen removal filler for constructed wetland.

It can be seen from FIG. 8 that all the test groups have better removal effect on COD, and the removal effect of the constructed wetland with the multivalent manganese oxide filler is better than that of the conventional constructed wetland, which indicates that the multivalent manganese oxide prepared in the present invention has good removal performance on COD.
5. The performances of the multivalent manganese oxide filler in Example 2 and the manganese oxide fillers prepared in Comparative Example 1 and Comparative Example 2 were tested. The test method was the same as in 1 above, except that:
during the test, different groups were set according to the different fillers in the mixture (mixture of filler and gravel) placed 5-45 cm away from the bottom of the reactor, specifically:
group 1 (25% Mn-Eucalyptus leaf extract), the volume ratio of the multivalent manganese oxide filler prepared in Example 2 to the gravel was 25%, and gravel was filled in the rest positions of the reactor;
group 2 (25% Mn-Eucommia ulmoides leaf extract), the volume ratio of the manganese oxide filler prepared in Comparative Example 1 to the gravel was 25%, and gravel was filled in the rest positions of the reactor;
group 3 (25% Mn-Platycladus orientalis leaf extract), the volume ratio of the manganese oxide filler prepared in Comparative Example 2 to the gravel was 25%, and gravel was filled in the rest positions of the reactor; and
control group (conventional constructed wetland), the substrate of the constructed wetland reactor was only gravel.

The influent water and water feed modes in this test were the same as in 1 above.

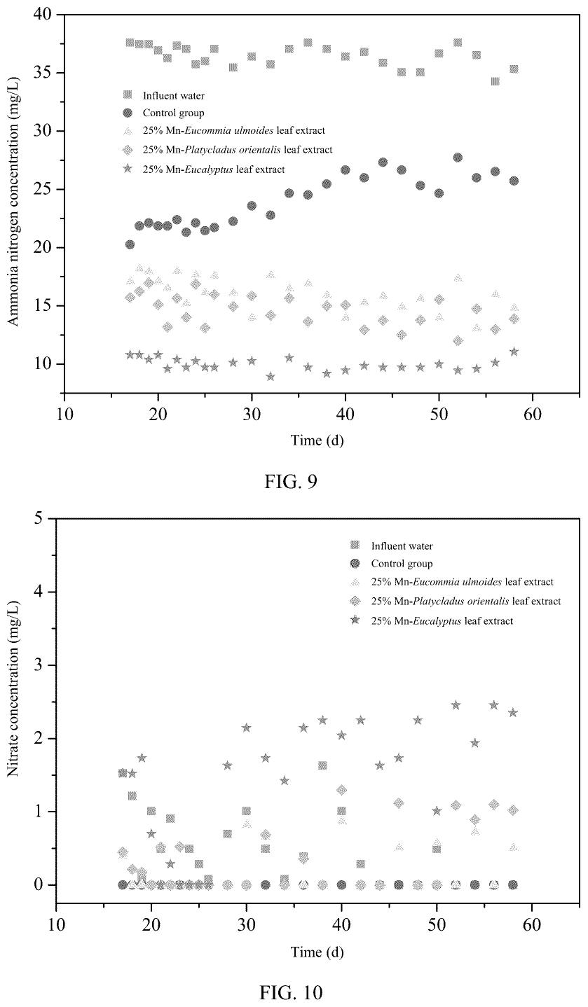

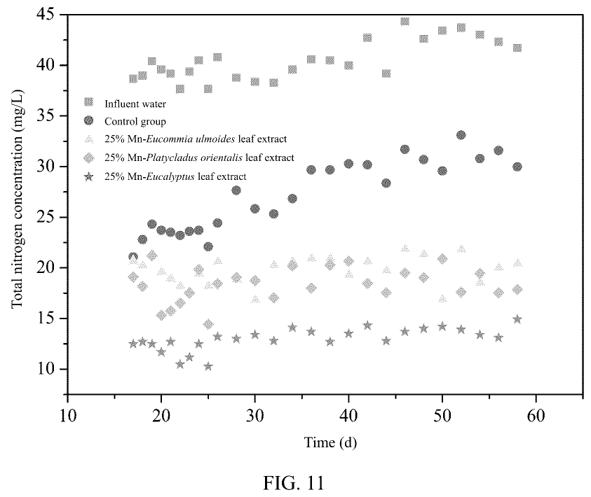

The test results are shown in FIGS. 9-11, wherein FIG. 9 shows a concentration change curve of ammonia nitrogen removal by a filler prepared from different extracts, FIG. 10 shows a concentration change curve of nitrate removal by a filler prepared from different extracts; and FIG. 11 shows a concentration change curve of total nitrogen removal by a filler prepared from different extracts.

It can be seen from FIG. 9 that the removal effect of the constructed wetland with the manganese oxide prepared from different extracts on ammonia nitrogen is better than that of the conventional constructed wetland, which indicates that the filler prepared in the present invention has a certain effect on the constructed wetland nitrogen removal. The ammonia nitrogen removal effect of the multivalent manganese oxide (i.e., Mn-Eucalyptus leaf extract) is significantly better than that of the manganese oxide filler (i.e., Mn-Eucommia ulmoides leaf extract) prepared from the Eucommia ulmoides leaf extract and that of the manganese oxide filler prepared from the Platycladus orientalis leaf extract (i.e., Mn-Platycladus orientalis leaf extract), which indicates that the type of extract has a certain effect on the constructed wetland nitrogen removal. The principle is that organic amines and quaternary ammonium ions rich in the Eucalyptus robusta Smith leaf extract serve as a template agent in the preparation process of the multivalent manganese oxide, so that the multivalent manganese oxide prepared in the present invention has a loose and porous structure, the specific surface area of the multivalent manganese oxide filler in the present invention is increased, and the nitrogen removal efficiency of the multivalent manganese oxide filler is improved.

It can be seen from FIG. 10 that the nitrate content is highest in the group 1 (multivalent manganese oxide test group, i.e., 25% Mn-Eucalyptus leaf extract), followed by the group 2 (i.e., 25% Mn-Eucommia ulmoides leaf extract) and group 3 (25% Mn-Platycladus orientalis leaf extract), and the nitrate content is the lowest in the control group, almost 0. The reason is that the nitrification process and the manganese ammonia oxidation process of the multivalent manganese oxide are performed to a greater extent, the ammonia nitrogen removal effect is better, and more nitrates are generated as intermediate products, which corresponds to the above ammonia nitrogen results.

It can be seen from FIG. 11 that the concentration change trend of total nitrogen in each test group is similar to that of ammonia nitrogen, and the removal effect of the group 1 constructed wetland with the multivalent manganese oxide filler (i.e., 25% Mn-Eucalyptus leaf extract) on the total nitrogen is significantly better than that of the group 2 (i.e., 25% Mn-Eucommia ulmoides leaf extract) and group 3 (25% Mn-Platycladus orientalis leaf extract) constructed wetlands, which indicates that the multivalent manganese oxide prepared in the present invention has good removal performance on the total nitrogen.

The above mentioned contents are only preferred embodiments of the present invention and are not intended to limit the present invention. Any modification, equivalent substitution, improvement and the like made within the spirit and principle of the present invention shall all fall within the scope of protection of the present invention.

What is claimed is:

1. A multivalent manganese oxide filler, comprising: manganese (II), manganese (III) and manganese (IV); wherein
a preparation method for the multivalent manganese oxide filler comprises the following steps:
step 1: adding a Eucalyptus robusta Smith leaf extract into a potassium permanganate solution for oxidation reaction, and stirring to finally form a suspension;
step 2: sequentially filtering and drying the suspension in the step 1 to obtain a sintering precursor; and
step 3: sintering the sintering precursor to obtain the multivalent manganese oxide filler.

2. The multivalent manganese oxide filler according to claim 1, wherein the oxidation reaction in the step 1 is performed for 2-3 h at room temperature.

3. The multivalent manganese oxide filler according to claim 2, wherein a solid-to-liquid ratio of the suspension in the step 1 is (2-3):50 g/mL.

4. The multivalent manganese oxide filler according to claim 3, wherein the Eucalyptus robusta Smith leaf extract in the step 1 has a particle size of 74-100 μm, and the potassium permanganate solution in the step 1 has a molar concentration of 0.15-0.3 mol/L.

5. The multivalent manganese oxide filler according to claim 4, wherein the drying in the step 2 is performed at a temperature of 70-80° C. for 24-36 h.

6. The multivalent manganese oxide filler according to claim 5, wherein the sintering in the step 3 is performed at a heating rate is 8-12° C./min and at a temperature of 600-900° C. in an atmosphere of air for 3-4 h.

7. The multivalent manganese oxide filler according to claim 6, wherein the sintering in the step 3 is performed at a heating rate is 10° C./min and at a temperature of 600° C. in an atmosphere of air for 3 h.

8. An application of the multivalent manganese oxide filler according to claim 1 in the constructed wetland nitrogen removal.
